(19) United States
(12) Patent Application Publication
(10) Pub. No.: US 2022/0401855 A1
(43) Pub. Date: Dec. 22, 2022

(54) DEVICE AND METHOD FOR EXTRACTING SLUDGE BETWEEN ORGANIC AND AQUEOUS PHASES

(71) Applicant: CONSULTORÍAS Y SERVICIOS MINEROS INTEGRALES LIMITADA, Copiapó (CL)

(72) Inventor: Eladio ROJAS VÉLIZ, Santiago (CL)

(21) Appl. No.: 17/807,254

(22) Filed: Jun. 16, 2022

(30) Foreign Application Priority Data
Jun. 16, 2021 (CL) 202101592

(51) Int. Cl. B01D 11/04; B01D 17/02

(52) U.S. Cl. CPC B01D 11/0446; B01D 17/0214

(57) ABSTRACT

Equipment to extract sludge (crud) from the interface (5) that is generated in a mixer-settler (mixer-settler) (1) in a solvent extraction process between an aqueous phase (3) and an organic phase (4) which allows continuous vacuum extraction and storage of said sludge, where the equipment comprises: a sludge collector (2) comprising: a transparent rigid tube (18), a plurality of floats (19) freely mounted along of said tube (18), a tube elbow (20) at a first end of the transparent rigid tube (18), a tube extension (20′), at the other end of the elbow (20), a suction nozzle (23) at the end of the tube extension (20′), an angle change handle (21) near a second end of the transparent rigid tube (18) to rotate the sludge catcher (2) according to the axis longitudinal (18′) of the transparent rigid tube (18), an extraction regulating valve (22) mounted on the gear change handle angle (21) that regulates the suction pressure inside the transparent rigid tube (18); a vacuum tank (6) that receives the sludge from the sludge collector (2); a vacuum system (7) that generates a vacuum inside the vacuum tank (6) to produce suction or vacuum suction in the sludge collector (2); and a pneumatic pump (8) that extracts the sludge from the tank vacuum (6) and transfers them to a plurality of containers (9) for storage; Method to extract lees (crud) from the interface that is generated in a mixer-decanter.

### TECHNICAL FIELD

The invention patent is developed in the field of equipment to remove contaminating substances (crud) that are formed in solvent extraction processes, specifically it refers to an equipment to extract said contaminants that are formed in the interface between a phase of organic and an aqueous phase in the mixers-settlers (settlers).

### PRIOR ART DESCRIPTION

The solvent extraction process consists of the purification and concentration by means of reagents of an organic nature of the solutions (PLS) that come out of the leaching heaps, in which said reagents selectively extract copper. In the solvent extraction process there is a copper extraction stage and a discharge stage (stripping) in order to obtain a purer and more concentrated solution (Rich Electrolyte) that then goes to the electrowinning stage. The stages of contact between the PLS or Poor Electrolyte with the organic reagent are carried out in a mixer-settler equipment (mixer-settler), generating in the decantation process the separation of an aqueous phase and an organic phase, the aqueous phase being of higher density remains under the organic phase. The PLS coming from the leach pads normally brings suspended solids that, in contact with the organic phase, generate a third phase that is evident in the decanter and is located between the organic phase and the aqueous phase. The substance present in this third phase is commonly called “loose” (crud) and is gelatinous in appearance, being composed of aqueous, organic and small amounts of fine solids. The sludge can influence the continuity of phases, the stability of the emulsion, the aqueous solution, the distribution of air, so the phases must be removed from the decanter and the drag from one phase to another, which contaminates the purity of the electrolyte. rich and produces losses of the organic phase.

In the state of the art, some documents can be mentioned that refer to the elimination of the sludge present in the interface between the organic phase and the aqueous phase in mixer-settlers in solvent extraction processes.

U.S. Pat. No. 4,126,551 can be cited disclosing an apparatus and method for handling solids in solvent extraction equipment, where said apparatus is used in combination with settlers and includes a retractable blade that moves along a tank containing the aqueous phase, the organic phase and the interface where the solids are found.

Another document to consider is US 2002020252, which discloses a process and equipment for extracting solids from the interface between the aqueous phase and the organic phase of a solvent extraction system. The equipment has an endless screw at or near said interface to extract the solids.

You can also consider the document CN104966537 that discloses a device and a method for removing crud from the interface of a pond with said device. The device comprises a liquid suction tube to extract liquid from the interface, a storage tank for the liquid it extracts, a filter medium to filter the liquid, retaining the crud, and a drainage tube to return the filtered liquid to the tank.

Finally, another document that should be mentioned is the patent CL 45923 that discloses a system for a mixer-settler equipment for solvent extraction plants, where a continuous and partial suction system is installed for emulsion of the dispersion band that is located in the organic-liquid interface at the end where the dispersion band touches the decanter outlet weirs, where the suction is carried out with an extraction receptacle and a dispersion duct.

None of the above documents teaches equipment such as that of the invention that allows for the selective extraction, by means of vacuum, of the sludge from the interface of solvent extraction processes in a manual and simple way that is easy to install and operate with a continuous process.

### SUMMARY OF THE INVENTION

The invention discloses equipment for extracting sludge (crud) from the interface that is generated in a mixer-settler (mixer-settler) in a solvent extraction process between an aqueous phase and an organic phase. The equipment allows the continuous extraction, by means of vacuum, and the storage of said sludge, comprising a sludge collector; a vacuum system and a vacuum tank with a lid on its upper part with two connections and a lower valve connected to the vacuum system, to the sludge collector and to a pneumatic pump, in which said pump is connected on one side to the lower valve and on the other to a plurality of containers that receive the linters sucked up by the equipment. The contents of the containers subsequently go through a recovery process outside the mixer-settlers. The sludge collector is a transparent rigid tube mounted on floats with which, by rotating said rigid tube, it can be located and act on the interface to suck the sludge into it. The rigid tube of the sludge collector must be transparent so that the equipment operator can verify, when the equipment is in operation, that the sludge is properly extracted from the interface.

### BRIEF DESCRIPTION OF THE FIGURES

FIG. 1 shows a general view of the equipment to extract lees and its components.

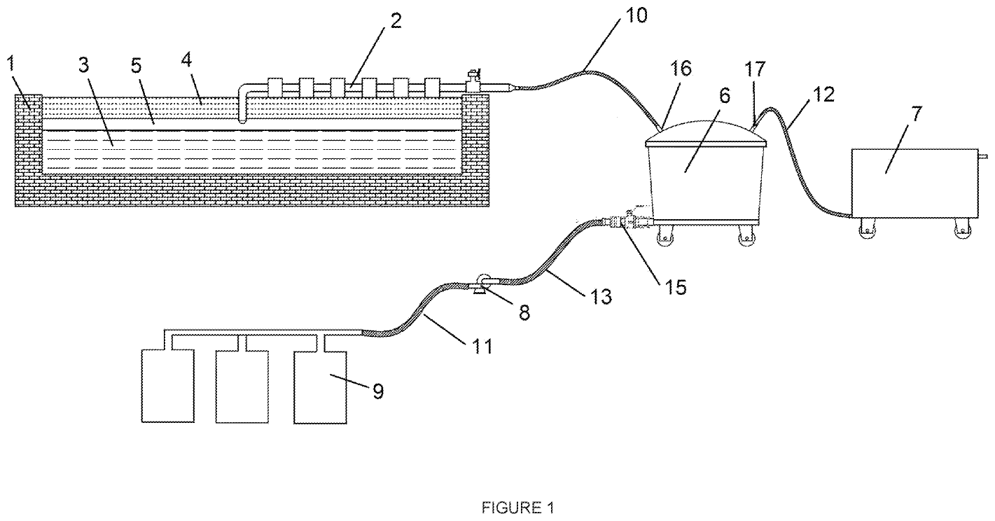

FIG. 2 shows a side view of the sludge collector.

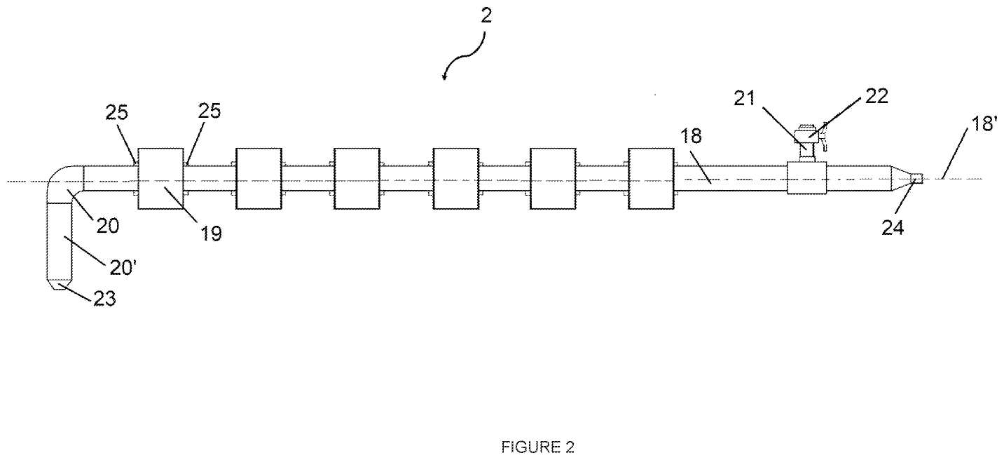

FIG. 3A shows a front view of the sludge collector in the mixer-settler entry position.

FIG. 3B shows a side view of the sludge collector with a suitable inclination to enter the interface.

FIG. 4 shows the use of extensions to increase the length of operation of the sludge collector.

### DETAILED DESCRIPTION OF THE INVENTION

The invention relates to equipment for extracting sludge (crud) from the interface (5) that is generated in a mixer-settler (mixer-settler) (1) in a solvent extraction process between an aqueous phase (3) and an organic phase (4). The equipment comprises:

a sludge collector (2);

vacuum tank (6);

a pneumatic pump (8);

a plurality of containers (9);

a vacuum system (7); Y

flexible hoses (10,11,12,13);

The vacuum tank (6) receives the lees from the lees collector (2), comprising an outlet valve (15) located in its lower part and an upper cover with a first upper connection (16) and a second upper connection (17). The first upper connection (16) is connected by a flexible hose (10) to the lint collector (2) that extracts the lint. The second upper connection (17) is connected by means of a flexible hose (12) to the vacuum system (7), where said system (7) generates the vacuum inside the vacuum tank (6). The lower valve (15) allows the evacuation of the sludge from the vacuum tank (6) by pumping a pneumatic pump (8) for its storage in a plurality of containers (9). The lower valve (15) is connected to the pneumatic pump (8) by means of a flexible hose (13). The pneumatic pump (8) is connected to the plurality of containers (9) by means of a flexible hose (11).

The vacuum system (7) is made up of a cubicle in which there are turbines and air filters inside that generate the appropriate vacuum levels for the operation of the system (7) to produce suction or aspiration through vacuum in the sludge collector (2).

The sludge collector (2) comprises a transparent rigid tube (18) with a diameter between 6.35 mm. (¼″) and 76.5 mm. (3″) preferably being 50.8 mm. (two″); a plurality of floats (19) attached along the tube (18) that allow the sludge catcher (2) to float on the organic phase (4) on the surface of the mixer-settler (1); a tube elbow (20) at a first end of the transparent rigid tube (18) that projects perpendicular to the longitudinal axis (18′) to the transparent rigid tube (18) by means of a tube extension (20′), in the other end of the tube elbow (20), which ends in a suction nozzle (23) through which the lint enters the interface (5) to the lint collector (2), where said first end is on the surface of the liquid in the mixer-settler (1); and an angle change handle (21) located near a second end of the transparent rigid tube (18), opposite the first end, where the operator is located, which allows the sludge catcher (2) to rotate according to the axis longitudinal (18′) of the transparent rigid tube (18), where the rotation of the sludge catcher (2) is independent of the plurality of floats (19) The transparent rigid tube (18), the tube elbow (20) and the tube extension (20′) are made of a material resistant to acid and organic solvent extraction processes. The length of the tube extension 20′ can be increased by joining additional tube lengths connected by hermetic screw joints.

The assembly of the plurality of floats (19) with the transparent rigid tube (18) is free and has stops (25) fixed to the tube (18) in each of the floats (19) in order to prevent the longitudinal movement of said floats along the transparent rigid tube (18), Likewise, said assembly allows the rotation of the transparent rigid tube (18) with respect to the floats (19). The floats are made of any material that resists acid and organic with a lower density than organic, this is 0.84 gr/cm³, such as fishing net floats, dumplings, containers with internal air or the like.

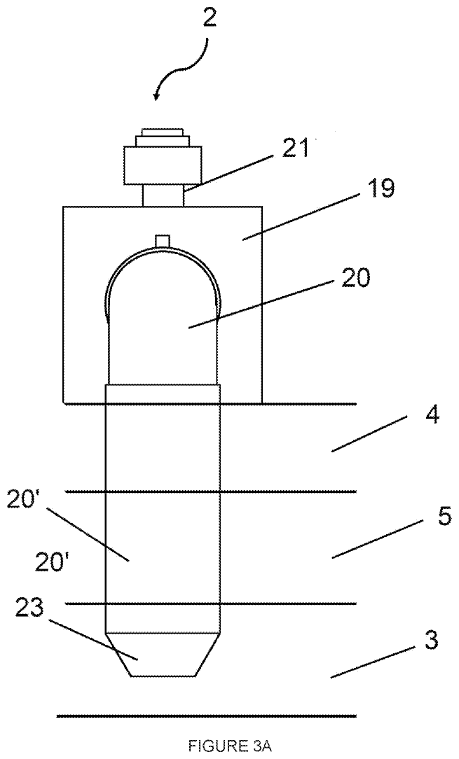

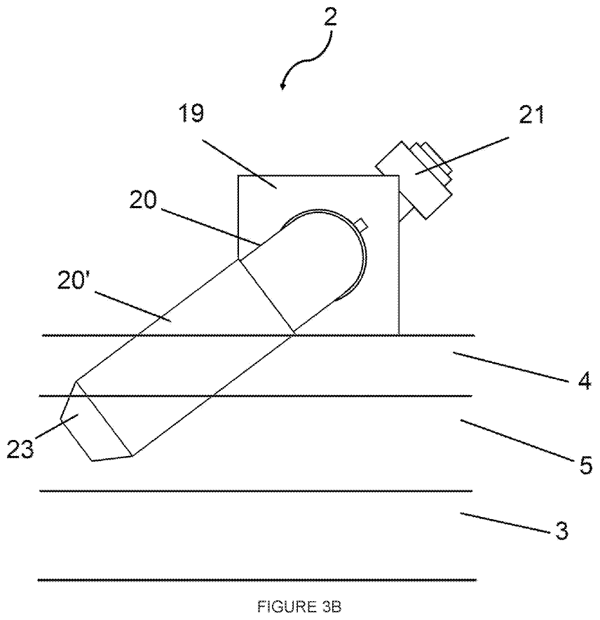

As can be seen in FIGS. 3A and 3B, turning the transparent rigid tube (18) by means of the angle change handle (21) allows finding the appropriate angle for the suction nozzle (23) to enter the interface (5). and remove the lint present there. The angle change handle (21) includes a mounted extraction regulator valve (22), which is in communication with the interior of the transparent rigid tube (18) at one end and atmospheric pressure at the other, which allows, through its total or partial opening, the regulation of the vacuum inside the transparent rigid tube (18) and, consequently, regulates the suction pressure inside the transparent rigid tube (18) and the extraction generated in the suction nozzle (23).). The second end of the transparent rigid tube (18) further comprises a vacuum connector (24) to connect the flexible hose (10).

The equipment to suck and store the sludge obtained from the interface (5) between the aqueous (3) and organic (4) phases operates by connecting the vacuum system (7) to the vacuum tank (6) through the flexible hose (12) in the second upper connection (17) of the upper cover of the vacuum tank (6), in such a way as to achieve an adequate vacuum pressure to allow the suction of the sludge through the sludge collector (2).

For the suction from the interface (5), the sludge collector (2) is operated by placing it on the surface of the liquid in the mixer-settler (1) in such a way that it floats on the surface of said liquid on the organic phase (4). by means of the plurality of floats (19) in the transparent rigid tube (18). The vacuum generated in the vacuum tank (6) generates the suction of liquid from the mixer-settler (1) by means of a sludge collector (2). For a correct extraction of the lint, it is necessary to rotate the lint collector (2), with respect to the longitudinal axis (18′) of the transparent rigid tube (18) by means of the angle change handle (21), up to a suitable angle so that the suction nozzle (23) located at the first end of the transparent rigid tube (18) reaches the interface (5) where the lint is found. The operator must observe what is being pumped into the vacuum tank (6) through the transparent rigid tube (18) and when he notices that the sludge is being pumped from the interface (5), maintain the appropriate angle to continue with the operation of sludge suction. The operator can increase or decrease the suction pressure inside the transparent rigid tube (18) by opening or closing the extraction regulator valve (22) on the angle change handle (21).

The suction of the sludge inside the vacuum tank (6) towards the plurality of containers (9) is carried out through the lower valve (15) and by means of the pneumatic pump (8), connected by the flexible hoses (11,13).

The content recovered from the interface (5) and stored in the plurality of containers (9) is sent for processing outside the mixer-settler zone (1) of the solvent extraction process.

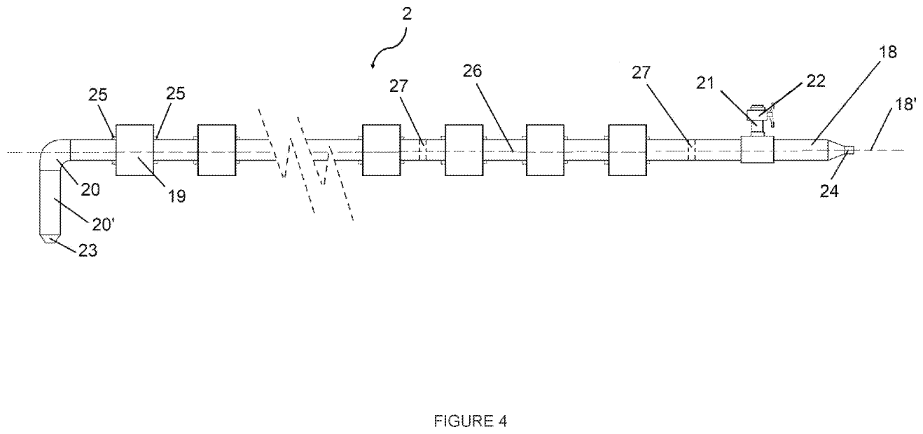

As shown in FIG. 4, optionally, the transparent rigid tube (18) can be formed by a plurality of sections of tube (26) connected by means of hermetic screwed joints (27) that allow the length of the transparent rigid tube to be adjusted (18) to the dimensions of the mixer-settler (1) from which the lees are extracted. The tube sections (26) can be of different lengths, so that new tube sections (26) of different lengths can be inserted and/or added to regulate the operating length of the transparent rigid tube (18). Alternatively, the transparent rigid tube (18) can be formed by a single tube to which additional sections of tube (26) can be added, connected by hermetic screwed joints (27), to increase its length.

The method to use the equipment to extract sludge (crud) from the interface (5) that is generated in a mixer-decanter (1) in a solvent extraction process between an aqueous phase (3) and an organic phase (4) includes the stages of
providing the vacuum tank (6) with a top cover; the vacuum system (7); a pneumatic pump (8); a plurality of containers (9) and a sludge collector (2) comprising a rigid transparent tube (18); a plurality of floats (19) attached along the tube; a tube elbow (20) at a first end of the transparent rigid tube (18) projecting perpendicularly to the tube (18) by means of a tube extension (20′) ending in a suction nozzle (23); an angle change handle (21) at a second end of the transparent rigid tube (18), opposite the first end, to rotate the lint catcher (2) according to the longitudinal axis (18′) of the transparent rigid tube (18); and a draw regulating valve (22) mounted on the angle change handle (21) to regulate the suction pressure inside the transparent rigid tube (18);
connect the sludge collector (2) to the vacuum tank (6) by means of a flexible hose (10) in a first upper connection (16) of the upper cover;
connect the vacuum system (7) to the vacuum tank (6) by means of a flexible hose (12) in a second upper connection (17) of the upper cover;
connect the inlet of the pneumatic pump (8) to the vacuum tank (6) by means of a flexible hose (13) to an outlet valve (15) at the bottom of the vacuum tank (6);
connecting the output of the pneumatic pump (8) to the plurality of containers (19) by means of a flexible hose (11);
place the sludge collector (2) on the surface of the liquid in the mixer-settler (1) so that the first end of the transparent rigid tube (18) is on said surface with the tube extension (20′) in a vertical position; the sludge collector (2) floats in the liquid in the mixer-settler (1) by means of the plurality of floats (19);
activate the vacuum system (7) and the pneumatic pump (8);
suck through the suction nozzle (23) of the sludge collector (2) in the liquid in the mixer-decanter (1);
Rotate the sludge collector (2) with respect to the longitudinal axis (18′) of the transparent rigid tube (18) at a suitable angle so that the suction nozzle (23) is located at the interface (5) where they meet you erase them;
suck the contents of the sludge inside the vacuum tank (6) by means of the pneumatic pump (8) through the flexible hoses (13, 11) and the outlet valve (15) towards the plurality of containers (9) to your storage.

The adequate angle of rotation of the transparent rigid tube (18), to keep the suction nozzle (23) in the interface (5), is found by visually verifying the fluid that passes through the tube (18) until identifying the presence of you erase

During the operation of the equipment, the suction generated in the suction nozzle (23) is regulated by varying the suction pressure inside the transparent rigid tube (18) by opening or closing the extraction regulating valve (22) mounted on the handle. of change of angle (21) that is in communication with the interior of the transparent rigid tube (18) at one end and atmospheric pressure at the other end.

Subsequently, the plurality of containers (9) are transferred for processing out of the mixer-settler area (1) of the solvent extraction process.

1. A device for extracting sludge (crud) from an interface generated in a mixer-settler in a solvent extraction process between an aqueous phase and an organic phase, comprising:
a sludge collector (2) including:
a transparent rigid tube (18);
a plurality of floats (19) freely mounted along the transparent rigid tube (18) that rotate with respect to an axis line (18′) of said transparent rigid tube (18);
a plurality of stops (25) fixed to the transparent rigid tube (18) that prevent the longitudinal displacement of the plurality of floats (19) along said transparent rigid tube (18);
a tube elbow (20) at a first end of the transparent rigid tube (18);
a tube extension (20′), at the other end of the elbow (20), projecting perpendicularly to the longitudinal axis (18′) of the perpendicular rigid tube (18);
a suction nozzle (23) at the end of the tube extension (20′);
an angle change handle (21) located near a second end of the transparent rigid tube (18), opposite said first end, to rotate the sludge catcher (2) according to the longitudinal axis (18′) of the tube transparent rigid (18);
an extraction regulating valve (22) mounted on the angle change handle (21) that regulates the suction pressure inside the transparent rigid tube (18);
a vacuum tank (6) that receives the lees from the lees collector (2), comprising an outlet valve (15) located in its lower part and an upper cover with a first upper connection (16) and a second connection upper (17);
a vacuum system (7) that generates vacuum inside the vacuum tank (6) to produce suction or suction by vacuum in the sludge collector (2);
a pneumatic pump (8) that extracts the lees from the vacuum tank (6) and transfers them to a plurality of containers (9) for storage.

2. The device according to claim 1, wherein a density of the material of the plurality of floats (19) is less than 0.84 gr/cm³.

3. The device according to claim 1, wherein the plurality of floats (19) is chosen between floats of fishing nets, balls, or containers with internal air.

4. The device according to claim 1, wherein a diameter of the transparent rigid tube (18) is between 6.35 mm. (¼″) and 76.5 mm. (3″).

5. The device according to claim 1, wherein the lees collector (2) is connected to the first upper connection (16) of the vacuum tank (6) by a flexible hose (10).

6. The device according to claim 5, wherein the transparent rigid tube (18) comprises a vacuum connector (24) at its second end to connect the flexible hose (10).

7. The device according to claim 1, wherein the vacuum system (7) is connected to the second upper connection (17) of the vacuum tank (6) by a flexible hose (12).

8. The device according to claim 1, wherein the pneumatic pump is connected to the lower valve (15) of the vacuum tank (6) by a flexible hose (13).

9. The device according to claim 1, wherein the pneumatic pump (8) is connected to the plurality of containers (9) by a flexible hose (11).

10. The device according to claim 1, wherein the transparent rigid tube (18), the tube elbow (20), the tube extension (20′) and the plurality of floats (19) are of a material resist acid and organic solvent extraction processes.

11. The device according to claim 1, wherein the transparent rigid tube (18) is formed by a plurality of tube sections (26) connected by hermetic screwed joints (27).

12. The device according to claim 11, wherein additional sections of tube (26) connected by hermetic screwed joints (27) are added to the transparent rigid tube (18), to increase its length.

13. The device according to claim 1, wherein the tube extension (20′) has attached additional tube sections connected by hermetic screwed joints.

14. The device according to claim 1, wherein the vacuum system (7) includes a cubicle in which there are turbines and air filters that generate vacuum levels.

15. A method for extracting sludge (crud) from an interface generated in a mixer-settler in a solvent extraction process between an aqueous phase and an organic phase that allows the continuous extraction and storage of said sludge, the method comprising:
providing a vacuum tank (6) with a top cover; a vacuum system (7); a pneumatic pump (8); a plurality of containers (9) and a sludge collector (2) comprising a rigid transparent tube (18); a plurality of floats (19) attached along the tube; a tube elbow (20) at a first end of the transparent rigid tube (18) projecting perpendicularly to the tube (18) by a tube extension (20′) ending in a suction nozzle (23); an angle change handle (21) at a second end of the transparent rigid tube (18), opposite the first end, to rotate the lint catcher (2) according to the longitudinal axis (18′) of the transparent rigid tube (18); and a draw throttle valve (22) mounted on the angle change handle (21);
connecting the sludge collector (2) to the vacuum tank (6) by a flexible hose (10) in a first upper connection (16) of the upper cover;
connecting the vacuum system (7) to the vacuum tank (6) by a flexible hose (12) in a second upper connection (17) of the upper cover;
connecting the inlet of the pneumatic pump (8) to the vacuum tank (6) by a flexible hose (13) to an outlet valve (15) at the bottom of the vacuum tank (6);
connecting the output of the pneumatic pump (8) to the plurality of containers (19) by a flexible hose (11);
placing the sludge collector (2) on the surface of the liquid in the mixer-settler (1) so that a first end of the transparent rigid tube (18) is on said surface with the tube extension (20′) in a vertical position;
activating the vacuum system (7) and the pneumatic pump (8);
sucking through the suction nozzle (23) of the sludge collector (2) in the liquid in the mixer-decanter (1);
rotating the sludge collector (2) with respect to a longitudinal axis (18′) of the transparent rigid tube (18) at a suitable angle so that the suction nozzle (23) is located at the interface (5) where they meet; and
sucking the contents of the sludge inside the vacuum tank (6) using the pneumatic pump (8) through the flexible hoses (13, 11) and the outlet valve (15) towards the plurality of containers (9).

16. The method of claim 15, wherein an appropriate angle of rotation of the transparent rigid tube (18), to maintain the suction nozzle (23) in the interface (5), is found by visually verifying the fluid which passes through the tube (18) until the presence of lint is identified.

17. The method of claim 15, wherein suction generated in the suction nozzle (23) is regulated by varying suction pressure inside the transparent rigid tube (18) by opening or closing the regulating valve extraction (22).
